(19) United States
(12) Patent Application Publication
(10) Pub. No.: US 2018/0259478 A1
(43) Pub. Date: Sep. 13, 2018

(54) GAS SENSOR

(71) Applicants: NGK SPARK PLUG CO. LTD., Nagoya-shi (JP); SPIROSURE, INC., Pleasanton, CA (US)

(72) Inventors: Koji OMORI, Niwa-gun (JP); Tatsunori ITO, Inazawa-shi (JP); Hiroyuki NISHIYAMA, Konan-shi (JP); Masahiro TAKAKURA, Komaki-shi (JP); Solomon SSENYANGE, Fremont, CA (US); Ryan LEARD, Oakland, CA (US)

(73) Assignees: NGK SPARK PLUG CO. LTD., Nagoya-shi (JP); SPIROSURE, INC., Pleasanton, CA (US)

(21) Appl. No.: 15/451,934

(22) Filed: Mar. 7, 2017

(51) Int. Cl. G01N 27/407; G01N 27/406

(52) U.S. Cl. CPC G01N 27/4075; G01N 27/4067

(57) ABSTRACT

A gas sensor including a conversion section for converting NO contained in a gas under measurement to NO₂, and a detection section for detecting NO₂ concentration in the gas under measurement after having passed through the conversion section. The conversion section includes a substrate portion which defines a flow passage for the gas under measurement, and a porous catalyst layer disposed on a surface of the substrate portion which converts NO to NO₂. The flow passage has a hollow space in which the catalyst layer is not present and through which the gas under measurement flows. The catalyst layer has a thickness of 4 to 300 μm as measured between the substrate portion and an outermost surface of the catalyst layer, the outermost surface being exposed to the hollow space.

### BACKGROUND OF THE INVENTION

### Field of the Invention

The present invention relates to a gas sensor for detecting the concentration of a gas component contained in a gas under measurement such as exhaled breath.

### Description of the Related Art

A sensor has been known which measures NOx contained at a very low concentration (at a level of several ppb to several hundreds of ppb) in exhaled breath for the purpose of, for example, diagnosis of asthma (see U.S. Patent Application Publication No. 2015/0250408 incorporated herein by reference in its entirety, including but not limited to, FIG. 6B).

This sensor is configured as a single unit by combining a conversion section including a catalyst formed of platinum-bearing zeolite for converting NO in exhaled breath to NO₂ and a detection section including a mixed-potential sensor element for detecting NO₂.

The conversion section has a structure in which a catalyst layer is applied to a surface of a ceramic substrate and is fired, a through hole for allowing passage of exhaled breath (gas under measurement) is provided in the ceramic substrate, and a frame-shaped spacer of ceramic is adjacently stacked on the ceramic substrate. As a result, an internal space surrounded by the spacer and the catalyst layer, and the through hole serve as a flow passage for the gas under measurement, whereby the area of contact between the catalyst layer and the gas under measurement is increased.

Incidentally, if the thickness of the catalyst layer is excessively small, the amount of the catalyst becomes insufficient, and the performance (the function of converting a gas component to a particular component) of the catalyst is lowered. In the case where the catalyst layer is formed by applying it to a substrate, the layer formation (film formation) can be made easier by increasing the application thickness. In view of this, conventionally, the thickness of the catalyst layer has been rendered large.

However, in the case where the catalyst layer is porous, when the thickness of the catalyst layer is excessively increased, NO₂ generated at the surface of the catalyst layer reaches an inner part of the catalyst layer through pores present in the catalyst layer and is adsorbed by a catalytic substance. In this case, the amount of NO₂ supplied to the detection section (the sensor element) is rather decreased and the response sensitivity of the gas sensor is deteriorated.

### SUMMARY OF THE INVENTION

It is therefore an object of the present invention to provide a gas sensor in which the conversion from NO to NO₂ is performed to a sufficient degree, and which can prevent a decrease in the amount of NO₂ supplied to a detection section to thereby improve response sensitivity.

The above object of the present invention has been achieved by providing (1) a gas sensor including a conversion section for converting NO contained in a gas under measurement to NO₂, and a detection section for detecting a concentration of NO₂ in the gas under measurement after having passed through the conversion section. The conversion section includes a substrate portion which defines a flow passage for the gas under measurement, and a porous catalyst layer disposed on a surface of the substrate portion which converts NO to NO₂. The flow passage has a hollow space in which the catalyst layer is not present and through which the gas under measurement flows. The catalyst layer has a thickness of 4 to 300 μm as measured between the substrate portion and an outermost surface of the catalyst layer, the outermost surface being exposed to the hollow space.

The above gas sensor (1) of the present invention can prevent lowering of the performance of the catalyst, which would otherwise occur if the thickness of the catalyst layer is excessively small and the amount of the catalyst is insufficient. Also, the gas sensor can prevent a decrease in the amount of NO₂ supplied to the detection section, which decrease would otherwise occur when the thickness of the catalyst layer is excessively large and NO₂ produced at the surface of the catalyst layer is adsorbed by a catalytic substance inside the porous catalyst layer. As a result, the response sensitivity of the gas sensor can be improved.

In a preferred embodiment (2) of the gas sensor (1) above, the thickness of the catalyst layer is 8 to 50 μm.

In this case, the response sensitivity of the gas sensor can be further improved.

In another preferred embodiment (3) of the gas sensor (1) or (2) above, the catalyst layer is formed of Pt-bearing zeolite.

In this case, the porous catalyst layer can be reliably formed.

In yet another preferred embodiment (4) of the gas sensor of any of (1) to (3) above, the length of the hollow space as measured along any line segment crossing a transversal cross section of the hollow space is greater than the total thickness of the catalyst layer.

In this case, the gas under measurement can smoothly flow into the flow passage of the conversion section, and the desired performance of the catalyst can be reliably maintained.

According to the present invention, a gas sensor can be obtained in which the conversion from NO to NO₂ by a catalyst layer is performed to a sufficient degree. Further, the gas sensor of the present invention can prevent a decrease in the amount of NO₂ supplied to the detection section thereof, and which thus has improved response sensitivity.

### BRIEF DESCRIPTION OF THE DRAWINGS

FIG. 1 is a perspective view of a gas sensor according to an embodiment of the present invention;

FIG. 2 is an exploded perspective view of the gas sensor;

FIG. 3 is an exploded perspective view of a detection section;

FIG. 4 is an exploded perspective view of a conversion section;

FIG. 5 is a partial cross-sectional view of the conversion section taken along line A-A of FIG. 4;

FIG. 6 is a photograph showing a cross-sectional SEM image of a catalyst layer of an example; and

FIG. 7 is a graph showing the relationship between the thickness of a catalyst layer and the response sensitivity of the gas sensor.

### DESCRIPTION OF THE PREFERRED EMBODIMENTS

The present invention will now be described in detail with reference to the drawings. However, the present invention should not be construed as being limited thereto.

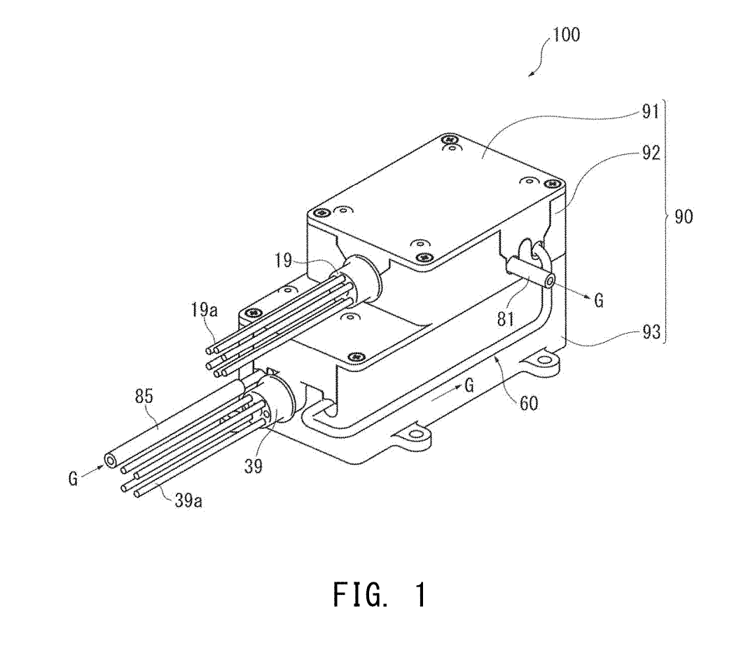

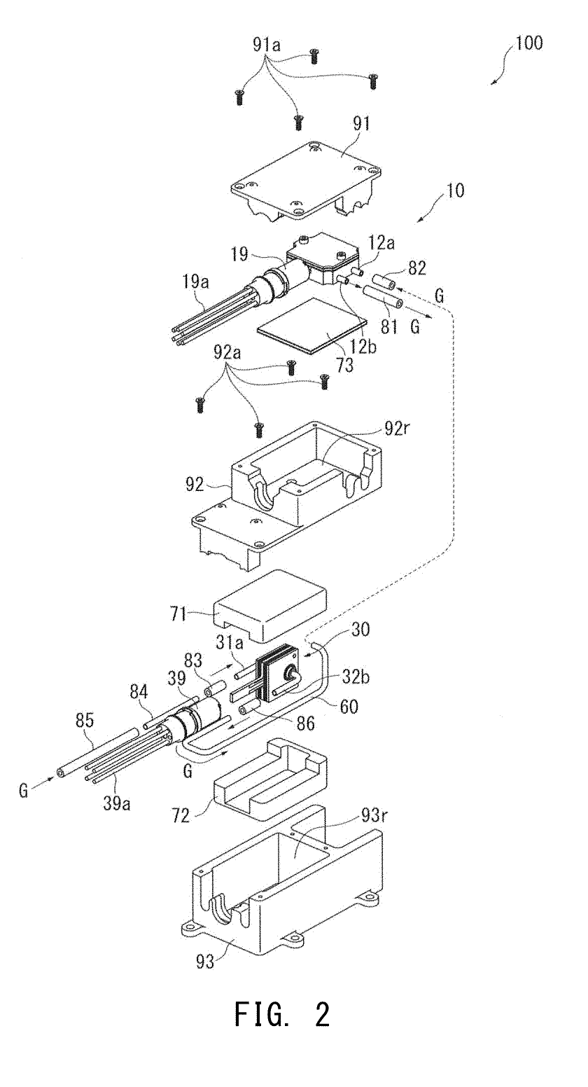

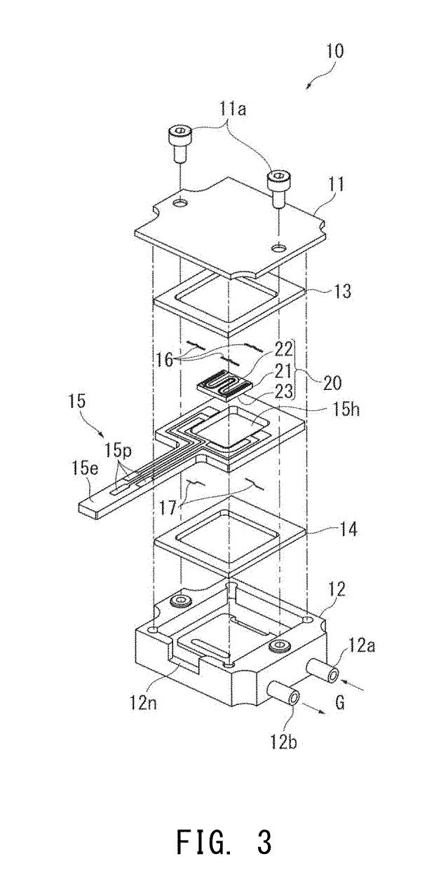

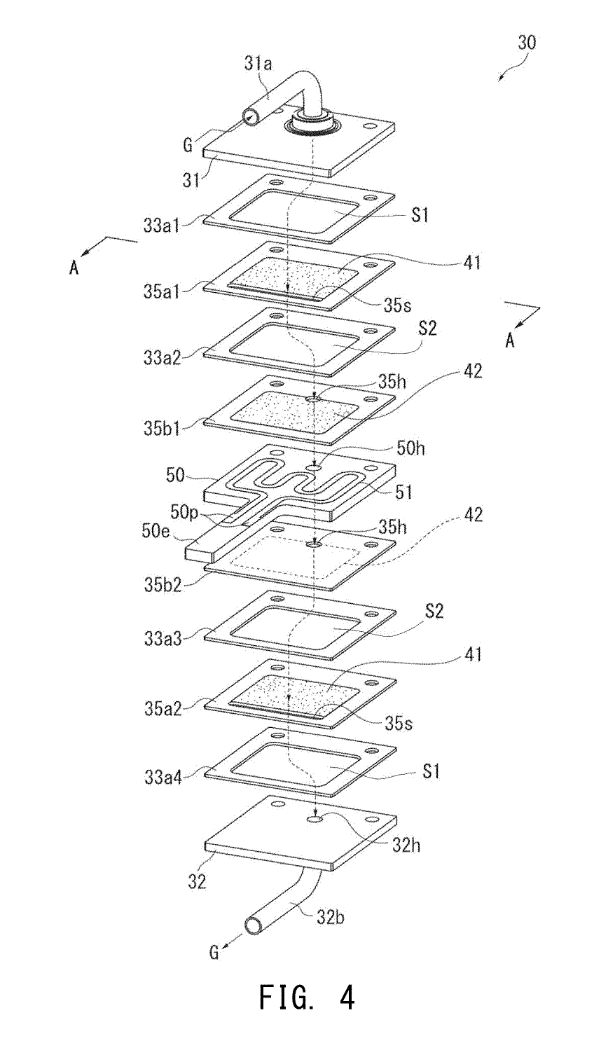

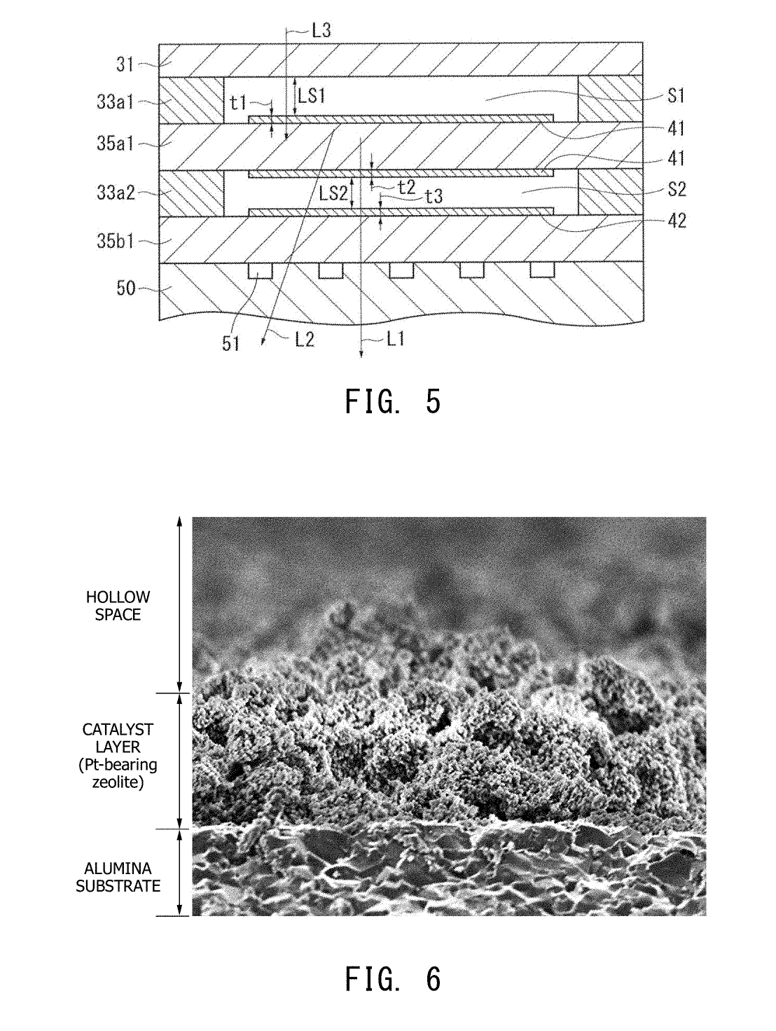

FIG. 1 is a perspective view of a gas sensor 100 according to an embodiment of the present invention. FIG. 2 is an exploded perspective view of the gas sensor 100. FIG. 3 is an exploded perspective view of a detection section 10. FIG. 4 is an exploded perspective view of a conversion section 30. FIG. 5 is a partial cross-sectional view of the conversion section 30 taken along line A-A of FIG. 4.

As shown in FIGS. 1 and 2, the gas sensor 100 includes a main body 90 serving as a housing, the detection section 10, the conversion section 30, and a main pipe (gas circulation pipe) 60. The detection section 10 and the conversion section 30 are accommodated in the main body 90, and the gas sensor 100 has a box-like shape as a whole.

The main body 90 includes a base 93 having an approximately rectangular shape and elongated in the left-right direction in FIG. 1; an upper case 92 having an approximately rectangular shape and shorter in the left-right direction in FIG. 1 than the base 93; and a lid 91 fastened to the upper case 92 with screws 91a to close an internal space 92r of the upper case 92 (see FIG. 2). The main body 90 is formed of a metal or a resin.

One longitudinal end (the right end in FIG. 1) of the upper case 92 is aligned with one longitudinal end (the right end in FIG. 1) of the base 93, and the upper case 92 is fastened to the upper surface of the base 93 with screws 92a to thereby close an internal space 93r of the base 93 (see FIG. 2).

As shown in FIG. 2, the detection section 10 is accommodated in the internal space 92r of the upper case 92, and a tubular cassette connector 19 is connected to the detection section 10. The conversion section 30 is accommodated in the internal space 93r of the base 93, and a tubular cassette connector 39 is connected to the conversion section 30.

A detection output from the detection section 10 which represents the concentration of a specific component (specifically, NO₂) is output from one end (the left end in FIG. 1) of the cassette connector 19 to the outside through lead wires 19a, and heater power for energizing a heater included in the detection section 10 is externally supplied through lead wires 19a. Heater power for heating the conversion section 30 is externally supplied to one end (the left end in FIG. 1) of the cassette connector 39 through lead wires 39a.

As shown in FIG. 1, exhaled breath G which is a gas under measurement is introduced into the conversion section 30 inside the base 93 through a sub-pipe 85, discharged from the conversion section 30, and then introduced into the detection section 10 inside the upper case 92 by way of the main pipe 60 provided outside the base 93. The detection section 10 detects a particular component (specifically, NO₂) in the exhaled breath G, and the exhaled breath G is discharged to the outside through a sub-pipe 81 provided outside the upper case 92.

Notably, as shown in FIG. 2, the conversion section 30 is accommodated in the internal space 93r of the base 93 in a state in which the conversion section 30 is covered with an upper heat insulating member 71 and a lower heat insulating member 72. The detection section 10 is accommodated in the internal space 92r of the upper case 92 with a sheet-shaped heat insulating member 73 disposed below the detection section 10.

The sub-pipe 85 and sub-pipes 84 and 83 are connected to an introduction pipe 31a of the conversion section 30, and one end of the main pipe 60 is connected to a discharge pipe 32b of the conversion section 30 through a sub-pipe 86. The other end of the main pipe 60 is connected to an introduction pipe 12a of the detection section 10 through a sub-pipe 82, and the sub-pipe 81 is connected to a discharge pipe 12b of the detection section 10.

Next, the detection section 10 will be described with reference to FIG. 3.

The detection section 10 includes a metal-made lower case 12 having an approximately rectangular box-like shape and having a recess on its upper surface (the surface facing upward in FIG. 3); a lid 11 for closing the recess of the lower case 12; a ceramic circuit board 15 accommodated in the lower case 12; rectangular frame-shaped seal members (packings) 13 and 14; an element unit 20 disposed within an opening 15h of the ceramic circuit board 15; and energizing members 16 and 17 for suspending and fixing the element unit 20 within the opening 15h. The ceramic circuit board 15 has a rectangular plate-shaped portion and a narrow width base end portion 15e protruding from one edge of the rectangular plate-shaped portion.

The seal members 13 and 14 and a forward end portion of the ceramic circuit board 15 are accommodated in the internal space of the lower case 12, and the narrow width base end portion 15e of the ceramic circuit board 15 protrudes from the lower case 12 through a notch 12n of the lower case 12.

The lid 11 is disposed on the seal member 13 and fastened to the lower case 12 with bolts 11a. As a result, the seal members 13 and 14 are pressed between the lower case 12 and the lid 11, and the ceramic circuit board 15 is thereby sealed.

The introduction pipe 12a and the discharge pipe 12b for the exhaled breath G are attached to one side wall (the right side wall in FIG. 3) of the lower case 12. The exhaled breath G introduced into the lower case 12 through the introduction pipe 12a comes into contact with the element unit 20, and the concentration of the specific component is detected. The exhaled breath G is then discharged to the outside through the discharge pipe 12b.

The element unit 20 has an approximately rectangular plate-like shape and includes a substrate 21, a first heater 22 disposed on an upper surface (the surface facing upward in FIG. 4) of the substrate 21, and a detection element 23 disposed on a lower surface of the substrate 21. The element unit 20 has an integral structure in which the detection element 23 and the first heater 22 are stacked on the lower and upper surfaces, respectively, of the substrate 21.

The detection element 23 has an electric characteristic which changes with the concentration of the specific component, and the changed electric characteristic is detected so as to determine the concentration of the specific component. When the first heater 22 is energized, the first heater 22 generates heat so as to heat the detection element 23 to a first temperature, which is the operating temperature of the detection element 23. Output terminals of the detection element 23 and energization terminals of the first heater 22 are suspended by the energizing members 16 and 17 and thereby fixed and electrically connected to the ceramic circuit board 15. The element unit 20 includes a temperature sensor for measuring the temperature of the first heater 22. The temperature sensor is formed into a prescribed pattern on the surface of the substrate 21 on which the first heater 22 is disposed.

The substrate 21 may be, for example, a ceramic substrate. The detection element 23 may be formed as, for example, a known mixed potential NOx (nitrogen oxide) sensor including a solid electrolyte layer and a pair of electrodes disposed on surfaces of the solid electrolyte layer. The first heater 22 is a heat generation resistor made of Pt and has a meandering pattern.

In the present embodiment, the ceramic circuit board 15, the lid 11, the lower case 12, the seal members 13 and 14, and the element unit 20 in which the detection element 23 and the first heater 22 are disposed on the substrate 21 are integrated and form a unit, to thereby constitute the detection section 10.

A plurality of conductive pads 15p are disposed on the front and back sides of the base end portion 15e of the ceramic circuit board 15 and are electrically connected to the detection element 23 and the first heater 22 through lead portions and the energizing members 16 and 17. The conductive pads 15p on the back side of the ceramic circuit board 15 are not illustrated. An electric signal from the detection element 23 is outputted through the conductive pads formed on the back side of the ceramic circuit board 15. Further, electric power is externally supplied to the first heater 22 through the conductive pads 15p formed on the front side of the ceramic circuit board 15 to energize the first heater 22, and the first heater 22 thereby generates heat.

As shown in FIG. 2, when the base end portion 15e of the ceramic circuit board 15 is inserted into the cassette connector 19, spring terminals (not shown) within the cassette connector 19 come into elastic contact with the conductive pads 15p of the base end portion 15e and are thereby electrically connected to the conductive pads 15p. The lead wires 19a are connected to the spring terminals, and the rear ends of the lead wires 19a are connected to an unillustrated female connector, whereby the lead wires 19a are connected to an external device.

Next, the conversion section 30 will be described with reference to FIGS. 4 and 5.

The conversion section 30 includes a rectangular plate-shaped upper lid 31; a rectangular frame-shaped spacer 33a1; a rectangular plate-shaped upper catalyst support 35a1 having catalyst layers 41 formed on opposite surfaces thereof; a spacer 33a2; a rectangular plate-shaped upper catalyst support 35b1 having a catalyst layer 42 formed on a surface thereof (facing upward in FIG. 4); a heater substrate 50 having a rectangular plate-shaped main body and a narrow width base end portion 50e protruding from one edge of the rectangular main body; a rectangular plate-shaped lower catalyst support 35b2 having a catalyst layer 42 formed on a surface thereof (facing downward in FIG. 4); a spacer 33a3; a rectangular plate-shaped lower catalyst support 35a2 having catalyst layers 41 formed on opposite surfaces thereof; a spacer 33a4; and a rectangular plate-shaped lower lid 32. These components are stacked in the above order from top to bottom in FIG. 4.

The upper catalyst support 35a1, the lower catalyst support 35a2, the upper catalyst support 35b1, and the lower catalyst support 35b2 correspond to the “substrate portion” of the invention.

The spacers 33a1 to 33a4 have the same shape and may be collectively referred to as spacers 33a. The upper catalyst support 35a1 and the lower catalyst support 35a2 have the same shape and may be collectively referred to as catalyst supports 35a. Similarly, the upper catalyst support 35b1 and the lower catalyst support 35b2 have the same shape and may be collectively referred to as catalyst supports 35b.

The above components 31, 32, 33a, 35a, 35b and 50 are formed of, for example, a ceramic (more specifically, alumina) and are hermetically bonded and stacked with, for example, a glass or inorganic adhesive layer therebetween.

Since the upper lid 31 and the lower lid 32 have the same shape, only the lower lid 32 will be described. The lower lid 32 includes a rectangular plate having a through hole 32h and a pipe 32b that is attached to the through hole 32h so as to extend therefrom. The pipe 32b protrudes from the through hole 32h to the outside and is bent 90° to extend along the plate surface of the lower lid 32, and the bent end portion extends beyond the peripheral edge of the lower lid 32 toward the base end portion 50e of the heater substrate 50. The upper lid 31 is similarly configured.

In the present example, the pipe 31a attached to the upper lid 31 serves as an introduction pipe for the exhaled breath G, and the pipe 32b serves as a discharge pipe.

On opposite surfaces of the upper catalyst support 35a1, the catalyst layers 41 are formed, by coating, to have an approximately rectangular shape in regions corresponding to the internal spaces of the spacers 33a1 and 33a2. The upper catalyst support 35a1 has a slit-shaped opening 35s formed in a portion thereof which is adjacent to one edge of each catalyst layer 41 (on the left side in FIG. 4). The exhaled breath G introduced from the pipe 31a comes into contact with the catalyst layer 41 on the upper side of the upper catalyst support 35a1 (the catalyst layer 41 will be referred to as the upper-side catalyst layer 41) within a hollow space S1 which is the internal space of the spacer 33a1, passes through the opening 35s, and then comes into contact with the catalyst layer 41 on the lower side of the upper catalyst support 35a1 (the catalyst layer 41 will be referred to as the lower-side catalyst layer 41) within a hollow space S2 which is the internal space of the spacer 33a2.

On one surface of the upper catalyst support 35b1 (the surface facing upward in FIG. 4), the catalyst layer 42 is formed, by coating, to have an approximately rectangular shape in a region corresponding to the internal space of the spacer 33a2, and the upper catalyst support 35b1 has a circular hole-shaped opening 35h at the center of one edge (the upper right edge in FIG. 4) of the catalyst layer 42. The exhaled breath G comes into contact with the above-described lower-side catalyst layer 41 and the catalyst layer 42 within the hollow space S2 which is the internal space of the spacer 33a2 and then flows downward through the opening 35h.

The other surface of the upper catalyst support 35b1 is in contact with the heater substrate 50. When a second heater 51 formed on the front surface of the heater substrate 50 and having a meandering pattern generates heat, the catalyst layer 42 is heated to a second temperature different from the first temperature by the heater substrate 50. A temperature sensor (not shown) for detecting the heating temperature of the second heater 51 is formed into a prescribed pattern on the back surface of the heater substrate 50. A circular hole-shaped opening 50h aligned with the opening 35h is formed in the heater substrate 50, and the exhaled breath G passing through the opening 35h flows downward through the opening 50h.

When the catalyst layer 42 is heated, the exhaled breath G in the internal space of the spacer 33a2 to which the catalyst layer 42 is exposed is heated, and the lower-side catalyst layer 41 exposed to the internal space of the spacer 33a2 is also heated. The heat of the lower-side catalyst layer 41 is also transferred to the upper-side catalyst layer 41 on the opposite surface (the upper surface) through the upper catalyst support 35a1.

The catalyst layers 41 and 42 each have a porous structure which converts the gas component contained in the exhaled breath G (specifically, NO) to the particular component (specifically, NO₂).

In the present embodiment, the upper lid 31, the lower lid 32, the upper catalyst supports 35a1 and 35b1 (including the catalyst layers 41 and 42), the lower catalyst supports 35a2 and 35b2 (including the catalyst layers 41 and 42), the heater substrate 50 on which the second heater 51 is disposed, and the spacers 33a1, 33a2, 33a3 and 33a4 are integrated and form a unit, to thereby constitute the conversion section 30.

A plurality of conductive pads 50p are disposed on the front and back surfaces of the base end portion 50e of the heater substrate 50 and are electrically connected to the second heater 51 and the temperature sensor (not shown) through lead portions. The second heater 51 is energized by electric power supplied from the outside through the conductive pads 50p and thereby generates heat.

As shown in FIG. 2, when the base end portion 50e of the heater substrate 50 is inserted into the cassette connector 39, spring terminals (not shown) within the cassette connector 39 are electrically connected to the conductive pads 50p of the base end portion 50e. The lead wires 39a are connected to the spring terminals, and the rear ends of the lead wires 39a are connected to an unillustrated female connector, whereby the lead wires 39a are connected to the external device.

Returning to FIG. 4, the lower catalyst support 35b2 is in contact with the lower surface (the surface facing downward in FIG. 4) of the heater substrate 50, and the catalyst layer 42 is formed, by coating, on the lower surface (the surface facing downward in FIG. 4) of the lower catalyst support 35b2 to have an approximately rectangular shape, as in the case of the upper catalyst support 35b1.

The lower catalyst support 35b2, the spacer 33a3, the lower catalyst support 35a2, the spacer 33a4, and the lower lid 32 that are on the lower side of the heater substrate 50 and the upper catalyst support 35b1, the spacer 33a2, the upper catalyst support 35a1, the spacer 33a1, and the upper lid 31 that are on the upper side of the heater substrate 50 are symmetric with respect to the plate surface of the heater substrate 50. Since the components on the lower side have substantially the same functions as the components on the upper side, their detailed description will be omitted.

The exhaled breath G flowing downward through the opening 50h and an opening 35h of the lower catalyst support 35b2 comes into contact with the catalyst layer 42 within the hollow space S2 which is the internal space of the spacer 33a3 and then comes into contact with the catalyst layer 41 on the upper side of the lower catalyst support 35a2. Then the exhaled breath G passes through an opening 35s, comes into contact with the catalyst layer 41 on the lower side of the lower catalyst support 35a2 within the hollow space S1 which is the internal space of the spacer 33a4, and is discharged from the pipe 32b.

In the manner described above, the exhaled breath G is brought into contact with the catalyst layers 42 and 41 heated to the second temperature, and the gas component (specifically, NO) contained in the exhaled breath G is converted to the specific component (specifically NO₂).

FIG. 5 is a partial cross-sectional view showing a transversal cross section of the hollow spaces S1 and S2 on the upper side of the heater substrate 50 taken along line A-A of FIG. 4.

FIG. 5 shows the thickness t1 of the upper-side catalyst layer 41 as measured between its outermost surface which faces (is exposed to) the hollow space S1 and the upper catalyst support 35a1, the thickness t2 of the lower-side catalyst layer 41 as measured between its outermost surface which faces (is exposed to) the hollow space S2 and the upper catalyst support 35a1, and the thickness t3 of the catalyst layer 42 as measured between its outermost surface which faces (is exposed to) the hollow space S2 and the upper catalyst support 35b1. Each of the thicknesses t1, t2 and t3 falls within a range of 4 to 300 μm at any position on the corresponding catalyst layer.

By setting the thicknesses t1 to t3 of the catalyst layers 41 and 42 to fall within the range of 4 to 300 μm, it becomes possible to attain a sufficiently high efficiency of conversion of nitrogen oxide (specifically, NO) to the particular component (specifically, NO₂) by the porous catalyst layers 41 and 42. It also becomes possible to prevent a decrease in the amount of NO₂ supplied to the detection section 10, which decrease would otherwise occur. This is because NO₂ produced at the surface of the catalyst layers 41 and 42 is adsorbed by a catalytic substance inside the porous catalyst layers 41 and 42. As a result, the response sensitivity of the gas sensor 100 can be improved.

When the thicknesses t1 to t3 of the catalyst layers 41 and 42 are less than 4 μm, the thicknesses t1 to t3 of the catalyst layers 41 and 42 becomes excessively small, and the amount of the catalyst becomes insufficient. Therefore, the performance of the catalyst is lowered. When the thicknesses t1 to t3 of the catalyst layers 41 and 42 exceed 300 μm, NO₂ produced at the surface of the catalyst layers 41 and 42 is adsorbed by the catalytic substance inside the porous catalyst layers 41 and 42. Therefore, the amount of NO₂ supplied to the detection section 10 is rather decreased, which lowers the response sensitivity of the gas sensor.

The catalyst layers 41 and 42 are porous layers formed of, for example, zeolite carrying Pt which converts NO contained in the exhaled breath G to NO₂. The porous layers can be formed by applying a paste of Pt-bearing zeolite particles and firing the paste. Since the zeolite particles are bonded together with gaps therebetween, the formed layers become porous.

The thicknesses of the catalyst layers 41 and 42 can be measured using a stylus-type or optical-type step gauge or profiler. In the case where the thicknesses of the catalyst layers cannot be measured directly by the above-described measurement method due to the shapes or structures of the layers (films), the thicknesses of the catalyst layers can be obtained by cutting the conversion section 30 along line A-A of FIG. 4 to obtain a cross section of the catalyst layers 41 and 42 as shown in FIG. 5. This is followed by performing the appearance observation using a secondary electron image obtained by a TEM or SEM or identifying the constituent elements using an EPMA or XPS to thereby determine the maximum depth at which the carried catalyst (Pt) is detected.

The thicknesses t1 to t3 are preferably set to 8 to 50 μm, more preferably set to 15 to 30 μm.

The present invention does not encompass a gas sensor having a porous catalyst layer completely fills the flow passage as viewed in its transversal cross section. This is because such a flow passage has a large flow resistance.

Also, as shown in FIG. 5, as measured along a line segment L1 crossing the transversal cross section of the hollow space S2, the length LS2 of the hollow space S2 is greater than the sum of the thicknesses t2 and t3 (total thickness) of the lower-side catalyst layer 41 and the catalyst layer 42. This relation is also satisfied even when measurement is made along any line segment (for example, L2) other than the line segment L1 so long as the selected line segment crosses the transversal cross section of the hollow space S2.

Also, as measured along a line segment L3 crossing the transversal cross section of the hollow space S1, the length LS1 of the hollow space S1 is greater than the total thickness t1 of the upper-side catalyst layer 41.

An increase in the flow resistance of the flow passage for the exhaled breath G in the conversion section 30 can be suppressed by defining the lengths of the hollow spaces and the total thicknesses of the catalyst layers such that they satisfy the above-described relations.

The expression “the total thickness of the catalyst layer” refers to the sum of the thicknesses of all catalyst layers which face (are exposed to) a particular hollow space or the thickness of a single catalyst layer which faces (is exposed to) a particular hollow space.

It will be appreciated that the present invention is not limited to the embodiment described above and encompasses various modifications and equivalents within the spirit and scope of the present invention.

The shape, materials, etc., of the gas sensor and the shapes, materials, etc., of the detection section and the conversion section which constitute the gas sensor are not limited to those in the above-described embodiment. The composition of the catalyst layers is not limited to that employed in the above-described embodiment so long as the catalyst layers are porous.

### Example 1

The conversion section 30 shown in FIG. 4 was fabricated and incorporated into the gas sensor 100 shown in FIGS. 1 to 3.

The catalyst layers 41 and 42 of the conversion section 30 were formed as follows. First, a catalyst powder containing powdery zeolite (product of Tosoh Corporation, product name: 320NAA) and Pt (4.5 mass %) borne thereby was prepared. Powdery zeolite was mixed into an aqueous solution obtained by dissolving powder of Pt(NH₃)₄Cl₂ into pure water, and an ion exchange process was performed so that Pt was borne by the zeolite surface.

A paste prepared from this mixed powder was printed, by a screen printing method, onto the surface of each of substrate portions formed of a fired alumina substrate, and baked at 775° C. The printing thickness of the mixed powder was changed within a predetermined range. Notably, the substrate portions are the upper catalyst support 35a1, the lower catalyst support 35a2, the upper catalyst support 35b1, and the lower catalyst support 35b2.

Subsequently, the substrate portions were bonded by glass and stacked so as to make the conversion section 30, and the conversion section 30 was incorporated into the gas sensor 100.

Next, the second heater 51 within the conversion section 30 of the gas sensor 100 was heated to 320° C., and air containing NO in an amount of 200 ppb was introduced into the conversion section 30 at a flow rate of 160 cc/min. Thus, NO was converted to NO₂, and other reducing gases were oxidized. The air treated by the conversion section 30 was introduced into the detection section 10 in the subsequent stage, and the NO₂ concentration of (detection voltage) was measured after elapse of 25 seconds. The NO₂ concentration was measured in a state in which the first heater 22 within the detection section 10 was heated to 460° C.

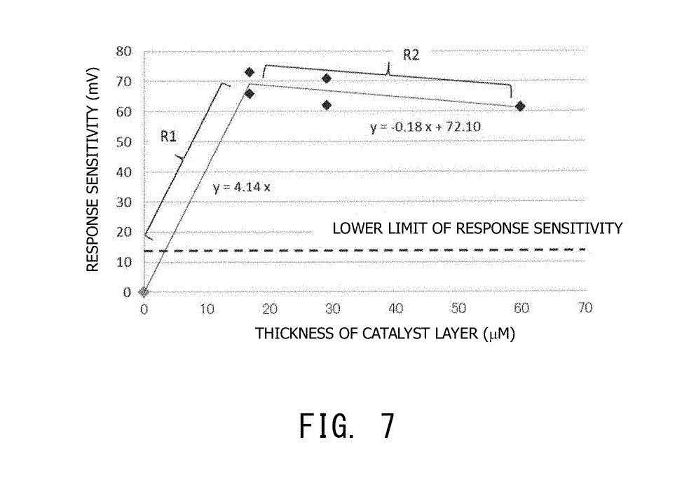

FIG. 6 shows a cross-sectional SEM image of the obtained catalyst layer 41. FIG. 7 shows the relation between the thickness of the catalyst layer 41 and the NO₂ concentration (response sensitivity represented by the detection voltage). Notably, the thickness of the catalyst layer 41 was measured using a stylus-type step gauge or profiler.

As is clear from FIG. 7, when the thickness of the catalyst layer 41 increases, (1) the response sensitivity (detection voltage) of the NO₂ concentration measurement of the detection section 10 increases in a first region R1, but (2) decreases when the thickness exceeds about 20 μm in a second region R2. Conceivably, this phenomenon occurs when the catalyst layer 41 is excessively thick, NO₂ is adsorbed by an inner part of the catalyst layer 41, and the amount of NO₂ supplied to the detection section 10 in the subsequent stage is decreased.

When the lower limit of the response sensitivity (the detection voltage) at or above which the NO₂ concentration can be measured accurately is considered to be 15 mV, the lower limit of the thickness of the catalyst layer 41 becomes 4 μm. This is because the inclination of an approximate straight line which represents the relation between the thickness of the catalyst layer 41 and the response sensitivity in the first region R1 is 4.14.

Meanwhile, since the inclination of an approximate straight line which represents the relation between the thickness of the catalyst layer 41 and the response sensitivity in the second region R2 is −0.18 and its y-intercept is 72.1, the upper limit of the thickness of the catalyst layer 41 at which the response sensitivity (detection voltage) reaches 15 mV becomes 300 μm.

Because of the above-described reasons, the thickness of the catalyst layer 41 was set to fall within the range of 4 to 300 μm.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

What is claimed is:

1. A gas sensor comprising:
a conversion section for converting NO contained in a gas under measurement to NO₂; and
a detection section for detecting NO₂ concentration in the gas under measurement after having passed through the conversion section, wherein
the conversion section includes a substrate portion which defines a flow passage for the gas under measurement, and a porous catalyst layer disposed on a surface of the substrate portion which converts NO to NO₂;
the flow passage has a hollow space in which the catalyst layer is not present and through which the gas under measurement flows; and
the catalyst layer has a thickness of 4 to 300 μm as measured between the substrate portion and an outermost surface of the catalyst layer, the outermost surface being exposed to the hollow space.

2. The gas sensor as claimed in claim 1, wherein the thickness of the catalyst layer is 8 to 50 μm.

3. The gas sensor as claimed in claim 1, wherein the catalyst layer is formed of Pt-bearing zeolite.

4. The gas sensor as claimed in claim 1, wherein a length of the hollow space as measured along any line segment crossing a transversal cross section of the hollow space is greater than the total thickness of the catalyst layer.
